(19) United States
(12) Patent Application Publication
(10) Pub. No.: US 2004/0253357 A1
(43) Pub. Date: Dec. 16, 2004

(54) Hard dragee-coating process

(76) Inventor: Dominique Ortiz De Zarate, Lestrem (FR)

Correspondence Address: STURM & FIX LLP, 206 SIXTH AVENUE, SUITE 1213, DES MOINES, IA, 50309-4076, US

(21) Appl. No.: 10/853,318

(22) Filed: May 25, 2004

(30) Foreign Application Priority Data
May 26, 2003 (FR) 0306320

(51) Int. Cl. A23L 1/00

(52) U.S. Cl. 426/546

(57) ABSTRACT

The present invention relates to a sugar-free hard dragee-coating process for creating a hard coating on the surface of a core and including at least one cycle comprising:

a step of applying a polyol syrup with a richness of greater than 80%,

a step of drying the cores,

wherein this cycle does not comprise a standing time between the step of applying the polyol syrup and the step of drying the cores.

The invention relates to a novel hard dragee-coating process. More specifically, the invention relates to a sugar-free hard dragee-coating process for considerably reducing the manufacturing time and for limiting the adhesion of the dragee-coated cores.

Hard dragee-coating is a unit operation employed in numerous fields and especially in confectionery and in pharmacy. It may also concern the industry of additives such as flavourings, sweeteners, vitamins, enzymes, acids and plant-based products. This operation consists in creating a hard coating on the surface of solid or pulverulent products, in order to protect them for various reasons or in order to give them visual or taste appeal.

Hard dragee-coating is directed towards obtaining a sweet, crunchy coat, which is always highly appreciated in the field of confectioneries such as chewing gums.

The coating of the core is performed in a drum that rotates about its axis, known as a dragee-coating machine, inside which is a plurality of cores forming a mass in motion, at the surface of which the material constituting the future shell is distributed in liquid form.

Dragee-coating always requires the use of a syrup containing crystallizable materials. The hard, crystalline coating is obtained by applying this syrup and evaporating off the water thereby supplied. This application must be repeated a very large number of times in order to obtain the desired degree of enlargement. Furthermore, it has hitherto always been necessary to observe a standing time between the end of the step of applying the syrup and the drying of the dragees, so as to correctly distribute the syrup over the surface of the cores during the standing time (during which time no syrup and no powder are applied to the surface of the cores and during which no drying air is blown into the rotating dragee-coating machine) and thus to obtain uniform crystallization of the syrup during the evaporation of the water it contains during the drying step.

Sugar-free hard dragee-coating has been known for a long time and described especially in patent EP 0 037 407, of which the Applicant is the proprietor, which concerns a process of dragee-coating with sorbitol. The coating is performed by successive cycles each comprising a first phase of addition of sorbitol syrup with a richness of greater than 80% by dry weight onto the bed of cores, a second phase (standing time) during which the addition is stopped while keeping the drum in rotation, and a third phase during which the shell with which the cores have been coated is dried by blowing them with hot, dry air so as to evaporate off the water introduced by the syrup and thus to crystallize the applied polyol. This technique, although satisfactory in terms of quality of the finished product, remains long in practice and may give rise to problems of adhesion of the cores to each other during the standing time.

Another method that is directed towards improving the state of the art has been described in patent EP-B1-0 625 311 B1, of which the Applicant is the proprietor.

This method can produce extremely hard and crunchy coatings without the need to perform a step of drying by blowing with air during each dragee-coating cycle. It consists in applying a polyol syrup with a richness at least equal to 90% by weight relative to its solids content, followed by a step of syrup distribution (first standing time), a step of applying a powder of the same polyol and a step of distributing the applied powder (second standing time). A standing time of fifteen seconds to two minutes is observed after each addition of the polyol syrup and before addition of the polyol powder.

Out of desire to further improve the state of the art, the Applicant thus set itself the task of further reducing the manufacturing times while at the same time optimizing the quality of the finished products, and, after extensive research studies, it has found, surprisingly and unexpectedly, that hard sugar-free coatings can be obtained in a considerably reduced manufacturing time, since the standing time following the end of the distribution of the polyol syrup is eliminated, followed either by a drying step or by steps of applying a powder, distributing this powder (standing) and drying.

Against all expectation, this process produces entirely satisfactory dragee-coating without causing any adhesion of the cores to each other, in a substantially shortened manufacturing time. The process in accordance with the invention allows a saving of fifteen seconds to two minutes per cycle, which is entirely advantageous when it is considered that the number of cycles performed is generally greater than 40.

One subject of the invention is thus a sugar-free hard dragee-coating process for creating a hard coating on the surface of a core and including at least one cycle comprising:

a step of applying a polyol syrup with a richness of greater than 80%,

a step of drying the cores,

wherein this cycle does not comprise a standing time between the step of applying the polyol syrup and the step of drying the cores.

According to one general embodiment of the invention, the process consists in uniformly wetting the surface of the products to be dragee-coated in motion in a dragee-coating turbine using the said polyol syrup. The polyol syrups concerned by the present invention are sugar alcohols chosen from the group consisting of sorbitol, maltitol, xylitol, mannitol-xylitol mixtures, erythritol, lactitol and isomalt (irrespective of the proportions between 1-1 GPM and 1-6 GPS in isomalt), and mixtures thereof.

A syrup with a polyol richness of at least 80% by dry weight, preferably of at least 90%, more preferably of at least 92% and even more preferably of at least 95% will preferably be used. The dragee-coating syrup may be prepared from any type of polyol sold in powder form. Ready-to-use syrups may also be used, for instance sorbitol syrups or maltitol syrups of high richness sold by the Applicant.

The solids content of the syrup is preferably between 60% and 85% by weight, more preferably between 65% and 80% and better still between 65% and 75%.

The polyol syrup used is brought to a temperature below 100° C. before application. In one advantageous embodiment, the syrup temperature is preferably less than 90° C. and even more preferably less than 70° C.

The temperature prevailing in the moving bed of cores to be coated is maintained at a value below 55° C., preferably between 10 and 50° C. and even more preferably between 15 and 40° C.

The means for maintaining the temperature within the mass of moving cores may consist of a device for blowing hot air of controlled temperature.

The thickness of the shell may be freely chosen especially as a function of the core to be dragee-coated or of the desired effects.

It is possible to add various additives to the polyol syrup to be sprayed, for instance dyes or flavourings. Binders such as plant gums, carboxymethylcellulose and gelatin or fatty substances such as monoglycerides and diglycerides may also be envisaged. It may also be envisaged to mix various polyols into the coating syrup. The dragee-coating syrup may also contain pigments such as calcium carbonate, titanium oxide, or a food-grade dye, and also intense sweeteners such as aspartame, acesulfame K, saccharin, sucralose, alitame, neotame, neohesperidin, thaumatin, sodium cyclamate or calcium cyclamate.

According to one particular embodiment of the invention, a high-purity sorbitol syrup will be used, such as, especially, Neosorb®70/02 sold by the Applicant, with a sorbitol richness on a dry basis of greater than 95%, and a solids content of 70%. The dragee-coating syrup prepared from Neosorb®70/02 may advantageously comprise 1.5% to 2% gum arabic, 1% titanium dioxide, may have a solids content of 65% and a temperature of 45° C. Such a dragee-coating syrup may contain flavourings, intense sweeteners and any other ingredient necessary for the dragee-coating.

By way of example, the composition of the solids content of the dragee-coating syrup may be 97.5% sorbitol, 1.5% gum arabic and 1% titanium dioxide.

The temperature of the bed of cores in motion is preferably maintained at a temperature of between 20 and 40° C. The number of syrup application-drying cycles is between 10 and 100 and preferably between 30 and 60. Very good results have been obtained by performing 55 successive cycles.

One variant of the process according to the invention consists in adding, after application of the syrup, an amount of high-purity polyol powder preferably of greater than 90% by weight and even more preferably greater than 95% by weight.

According to this variant, the process in accordance with the invention comprises at least one cycle including:

a step of applying a polyol syrup with a richness of greater than 80%,

a step of applying a polyol powder with a purity of greater than. 90% and preferably greater than 95% by weight,

a standing time to distribute the said powder,

a step of drying the cores,

wherein this cycle does not comprise a standing time between the syrup application step and the powder application step.

As regards the polyol powder, examples of powders that may be used include those sold under the names Neosorbe® for sorbitol, Xylisorbe® for xylitol, Palatinit® for isomalt, Maltisorb® for maltitol, Pearlitol® for mannitol and Lactya® for lactitol.

After distributing the powder and optionally drying the whole, a new wetting-supplying powder cycle may be performed. The process requires at least one, but preferably at least two, applications, in pulverulent form, of a high-purity polyol powder. These applications may be performed during the same cycle or during different cycles, given that a cycle is defined in the present invention as comprising only one application of the polyol syrup.

According to another variant of the process according to the invention, the said polyol powder consists of the same polyol as that predominantly present in the dragee-coating syrup. A person skilled in the art may then follow the teachings of patent EP 625 311 B1, of which the Applicant is the proprietor, as regards the compositions and working parameters, while at the same time using the process according to the invention that consists in eliminating at least one standing time after application of the syrup, i.e. in immediately distributing the powder at the end of the distribution of the syrup in at least one dragee-coating cycle.

It should be noted that the products to be dragee-coated may optionally be gum-treated beforehand according to the standard techniques known to those skilled in the art. Needless to say, it is possible to perform a final standard waxing treatment in order to improve the appearance of the products. In this case, fatty substances, lacquers or waxes are used, for example.

Another variant of the invention consists in performing multilayer dragee-coating, using several different polyols.

The process in accordance with the invention allows products of all types to be coated, such as, especially, food products such as confectioneries, chewing gums, bubble gums, tablets, lozenges, gelled articles, chewing pastes, hard-boiled sweets, chocolate products, dry fruits such as almonds or hazelnuts, pharmaceutical or veterinary products, for instance pills, tablets or products for animals, dietary products such as plant granules, seeds or grains, aggregated fertilizer powders, additives based on enzymes or microorganisms such as yeasts, detergent tablets, vitamins, flavourings, fragrances, acids, sweeteners or various active principles.

The implementation of the invention as described above allows the production of dragee-coated products of very good quality, with relatively short dragee-coating times, which are shorter than those of the processes of the prior art.

The invention will be understood more clearly with the aid of the examples that follow, which are intended to be illustrative and non-limiting.

### EXAMPLE 1

### Hard dragee-coating with sorbitol according to the invention

Equipment used: Driacoater 1200 dragee-coating machine

1. Composition of the coating syrup (65% solids—45° C.)

| | | Composition |
|---|---|---|
| | Ingredients | based on |
| | (kg) | solids |
| Sorbitol Neosorb ® 70/02 | 25.000 kg | 97.5% |
| Gum arabic | 0.270 kg | 1.5% |
| TiO₂ | 0.180 kg | 1.0% |
| Water | 2.165 kg | |
| | 27.615 kg | 100.00% |

2. Dragee-coating sequences and parameters (60 kg of chewing gums)

Phase 1=dedusting of the cores and preheating

| | Phase | | | | | | | | |
|---|---|---|---|---|---|---|---|---|---|
| | 2 | 3 | 4 | 5 | 6 | 7 | 8 | 9 | 10 |
| Number of | 5 | 5 | 5 | 10 | 10 | 11 | 3 | 5 | 1 |
| cycles | | | | | | | | | |
| Amount of syrup per | 0.4 | 0.6 | 0.7 | 0.9 | 1.1 | 1.2 | 0.8 | 0.4 | wax |
| cycle (kg) | | | | | | | | | |
| Standing time | 0 | 0 | 0 | 0 | 0 | 0 | 1.0 | 2.0 | |
| (min) | | | | | | | | | |
| Drying time | 3.5 | 3.5 | 3.5 | 3.5 | 4 | 4 | 3 | 1.5 | 5 |
| (min) | | | | | | | | | |
| Drying | 26 | 26 | 30 | 34 | 34 | 38 | 38 | 38 | 24 |
| temperature (° C.) | | | | | | | | | |

| | |
|---|---|
| Flow rate of | 12 |
| hot air/m³/min | |
| Spin speed of | 12 |
| dragee-coating | |
| machine (rpm) | |

The total dragee-coating time is 231 minutes for a degree of enlargement of 35%.

Eucalyptus flavouring was added to the dragee-coating syrup.

### EXAMPLE 2

### Hard dragee-coating with sorbitol according to the prior art

1. Composition of the coating syrup (65% solids—45° C.)

| | | Composition |
|---|---|---|
| | Ingredients | based on |
| | (kg) | solids |
| Sorbitol Neosorb ® 70/02 | 30.875 kg | 97.0% |
| Gum arabic | 0.341 kg | 1.5% |
| TiO₂ | 0.341 kg | 1.5% |
| Water | 3.445 kg | |
| | 35.000 kg | 100.00% |

2. Dragee-coating sequences and parameters (50 kg of chewing gums)

Phase 1 =dedusting of the cores and preheating

| | Phase | | | | | | | |
|---|---|---|---|---|---|---|---|---|
| | 2 | 3 | 4 | 5 | 6 | 7 | 8 | 9 |
| Number of | 4 | 9 | 6 | 12 | 19 | 4 | 5 | 1 |
| cycles | | | | | | | | |
| Amount of | 0.3 | 0.4 | 0.5 | 0.6 | 0.7 | 0.7 | 0.3 | wax |
| syrup per | | | | | | | | |
| cycle (kg) | | | | | | | | |
| Standing time | 0.3 | 0.3 | 0.3 | 0.3 | 0.5 | 0.5 | 2.0 | 10.0 |
| (min) | | | | | | | | |
| Drying time | 4.5 | 4.0 | 4.0 | 3.0 | 3.5 | 3.0 | 1.0 | 5.0 |
| (min) | | | | | | | | |
| Drying | 24 | 30 | 30 | 34 | 36 | 36 | 36 | 26 |
| temperature | | | | | | | | |
| (° C.) | | | | | | | | |
| Flow rate | 12 | | | | | | | |
| of hot | | | | | | | | |
| air/m³/min | | | | | | | | |
| Spin speed of | 9 | 12 | 12 | 12 | 12 | 12 | 8 | 12 |
| dragee-coating | | | | | | | | |
| machine (rpm) | | | | | | | | |

Flavouring (spearmint-menthol mixture) was added to the surface of the cores during phases 6, 7 and 8.

The total dragee-coating time is 246 minutes for a degree of enlargement of only 30%.

According to the invention (preceding example), less time is taken (231 minutes) to achieve a greater degree 15 of enlargement (35%).

The products are comparable in terms of organoleptic quality.

1. Sugar-free hard dragee-coating process for creating a hard coating on the surface of a core and including at least one cycle comprising:
a step of applying a polyol syrup with a richness of greater than 80%,
a step of drying the cores,
wherein this cycle does not comprise a standing time between the step of applying the polyol syrup and the step of drying the cores.

2. Process according to claim 1, wherein the said polyol syrup comprises, relative to its soluble solids content, at least 80% and preferably at least 88% by weight of polyol.

3. Process according to claim 1, wherein the said polyol syrup comprises a polyol chosen from the group consisting of sorbitol, maltitol, xylitol, mannitol, erythritol, lactitol and isomalt, and mixtures thereof.

4. Hard dragee-coating process including at least one cycle comprising:
a step of applying a polyol syrup with a richness of greater than 80%,
a step of applying a polyol powder with a purity of greater than 90% and preferably greater than 95% by weight,
a standing time to distribute the said powder,
a step of drying the cores,
wherein this cycle does not comprise a standing time between the syrup application step and the powder application step.

5. Process according to claim 4, wherein the said polyol syrup comprises, relative to its soluble solids content, at least 80% and preferably at least 88% by weight of polyol.

6. Process according to claim 4, wherein the said polyol syrup comprises a polyol chosen from the group consisting of sorbitol, maltitol, mannitol, xylitol, erythritol, lactitol and isomalt, and mixtures thereof.

7. Process according to claim 4, wherein the said powder consists of the same polyol as that predominantly present in the dragee-coating syrup.

8. Process according to claim 1, wherein the product to be dragee-coated is a food, veterinary, pharmaceutical or dietary product, a seed or grain, a fertilizer powder or an additive based on enzymes, microorganisms, vitamins, flavourings, fragrances, acids, sweeteners or active principles.

9. Process according to claim 4, wherein the product to be dragee-coated is a food, veterinary, pharmaceutical or dietary product, a seed or grain, a fertilizer powder or an additive based on enzymes, microorganisms, vitamins, flavourings, fragrances, acids, sweeteners or active principles.
